(19) United States
(12) Patent Application Publication
(10) Pub. No.: US 2011/0212864 A1
(43) Pub. Date: Sep. 1, 2011

(54) BENZOTRIAZOLE COMPOSITIONS

(76) Inventors: Isabelle RAPENNE-JACOB, Mulhouse (FR); Samuel EVANS, Marly (CH); Peter ROHRBACH, Liestal (CH); Martin VON BÜREN, Muttenz (CH)

(21) Appl. No.: 13/019,567

(22) Filed: Feb. 2, 2011

Related U.S. Application Data
(63) Continuation-in-part of application No. 11/667,779, filed on May 15, 2007, now abandoned.

(30) Foreign Application Priority Data
Nov. 22, 2004 (EP) 04105973.4

(51) Int. Cl. C10M 133/44; C09D 7/12

(52) U.S. Cl. 508/281; 106/287.21

(57) ABSTRACT

The invention relates to novel (benzo)triazole compositions comprising mixtures of benzotriazoles and N-substituted benzotriazoles in functional liquids, e.g. mineral oil. The mixtures can be prepared from readily obtainable starting materials, such as tolutriazole (TTA), alkyl aldehydes and cycloalkanols. The invention furthermore relates to a process for protecting metals, which are in contact with functional liquids comprising the mixtures.

### CROSS REFERENCE TO RELATED APPLICATIONS

This application is a continuation-in-part of and claims priority to U.S. patent application Ser. No. 11/667,779, filed on May 15, 2007, hereby incorporated by reference in its entirety, which claims priority to and all the advantages of International Patent Application No. PCT/EP05/55934, filed on Nov. 14, 2005, which claims priority to European Patent Application No. EP 04105973.4, filed on Nov. 22, 2004 in Europe, which is hereby incorporated by reference in its entirety.

The invention relates to novel benzotriazole compositions comprising mixtures of benzotriazoles and N-substituted benzotriazoles, the process for preparing N-substituted benzotriazoles and a method for improving the functional properties of lubricants, hydraulic or metal-working fluids or coating compositions.

Additives, which can be used as metal deactivators display their protective action in functional liquids, such as mineral oil or fuels, by deactivating the metal ions, such as copper or iron, contained therein. These metal ions can have catalytic effects in undesired oxidative decomposition processes of mineral oil or fuels. The protective action is explained by the formation of film-like layers on the surface of metals or by complex formation with metal ions.

EP-A-365 476 discloses benzotriazole compounds:

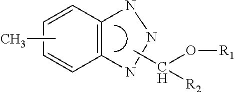

Wherein R₁ represents C₁-C₁₂ straight or branched chain alkyl; and

R₂ represents C₁-C₁₂ straight or branched chain alkyl interrupted by one or more O-atoms or represents C₅-C₁₂cycloalkyl;

and lubricant compositions comprising these benzotriazole compounds.

Owing to their volatility at high operating temperatures of machines, metal deactivators of the triazole type are problematic. Because of high temperatures, in particular in internal combustion engines and turbines, which are exposed to oils and fuels, the deactivator concentration can rapidly decrease with a corresponding reduction in the protective action.

It is a feature of the invention to prepare, from readily obtainable starting materials, such as tolutriazole (TTA), alkyl aldehydes and cycloalkanols, additive components which can be used in lubricant compositions as metal deactivators, possess improved solubility and, in functional liquids, have lower volatility than tolutriazole itself.

This is achieved by the present invention, which relates to novel benzotriazole compositions comprising mixtures of benzotriazoles and N-substituted benzotriazoles.

The invention relates to a composition comprising

A) A mixture consisting essentially of:
a) A benzotriazole compound:

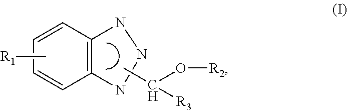

Wherein R₁ represents hydrogen or C₁-C₄alkyl;
R₂ represents a substituent selected from the group consisting of C₁-C₁₂alkyl, C₅-C₇cycloalkyl, (C₁-C₄alkyl)₁₋₃C₅-C₇cycloalkyl, C₅-C₇cycloalkyl-C₁-C₄alkyl,

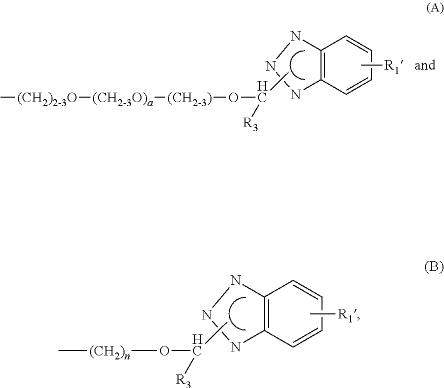

Wherein R₁′ is as defined as R₁;
The index a represents a numeral from 1 to 10; and
The index n represents a numeral from 2 to 8; and
R₃ represents hydrogen or a substituent selected from the group consisting of C₁-C₁₂alkyl, C₅-C₇cycloalkyl, (C₁-C₄alkyl)₁₋₃C₅-C₇cycloalkyl, C₅-C₇cycloalkyl-C₁-C₄alkyl, phenyl, phenyl-C₁-C₄alkyl, (C₁-C₄alkyl)₁₋₃phenyl and (C₁-C₄alkyl)₁₋₃phenyl-C₁-C₄alkyl;
b) A benzotriazole compound:

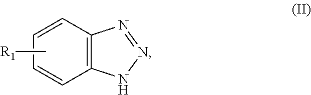

Wherein R₁ represents hydrogen or C₁-C₄alkyl; and, optionally,
c) A triazole compound:

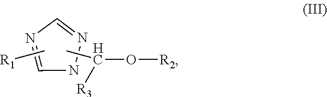

Wherein R₁ represents hydrogen or C₁-C₄alkyl;
R₂ represents a substituent selected from the group consisting of C₁-C₁₂alkyl, C₅-C₇cycloalkyl, (C₁-C₄alkyl)₁₋₃C₅-C₇cycloalkyl, C₅-C₇cycloalkyl-C₁-C₄alkyl,

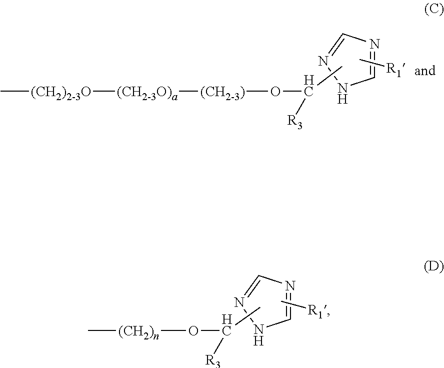

Wherein R₁′ is as defined as R₁; and
The index a represents a numeral from 1 to 10;
The index n represents a numeral from 2 to 8; and
R₃ represents hydrogen or a substituent selected from the group consisting of C₁-C₁₂alkyl, C₅-C₇cycloalkyl, (C₁-C₄alkyl)₁₋₃C₅-C₇cycloalkyl, C₅-C₇cycloalkyl-C₁-C₄alkyl, phenyl, phenyl-C₁-C₄alkyl, (C₁-C₄alkyl)₁₋₃phenyl and (C₁-C₄alkyl)₁₋₃phenyl-C₁-C₄alkyl;

B) A functional fluid selected from the group consisting of lubricants, hydraulic agents, metal working fluids and coating agents.

An alternate embodiment of the invention relates to a composition comprising

A) A mixture consisting essentially of:
a) A benzotriazole compound:

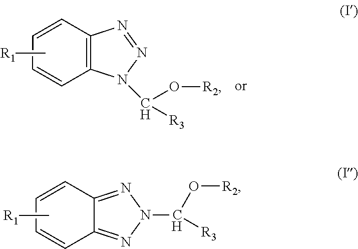

Wherein R₁ represents hydrogen or C₁-C₄alkyl;
R₂ represents a substituent selected from the group consisting of C₁-C₁₂alkyl, C₅-C₇cycloalkyl, (C₁-C₄alkyl)₁₋₃C₅-C₇cycloalkyl and C₅-C₇cycloalkyl-C₁-C₄alkyl; and
R₃ represents hydrogen or a substituent selected from the group consisting of C₁-C₁₂alkyl, C₅-C₇cycloalkyl, (C₁-C₄alkyl)₁₋₃C₅-C₇cycloalkyl, C₅-C₇cycloalkyl-C₁-C₄alkyl, phenyl, phenyl-C₁-C₄alkyl, (C₁-C₄alkyl)₁₋₃phenyl and (C₁-C₄alkyl)₁₋₃phenyl-C₁-C₄alkyl;
b) A benzotriazole compound:

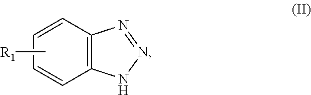

Wherein R₁ represents hydrogen or C₁-C₄alkyl; and, optionally,
c) A triazole compound:

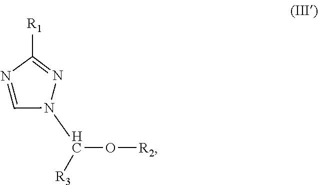

Wherein R₁ represents hydrogen or C₁-C₄alkyl;
R₂ represents a substituent selected from the group consisting of C₁-C₁₂alkyl, C₅-C₇cycloalkyl, (C₁-C₄alkyl)₁₋₃C₅-C₇cycloalkyl and C₅-C₇cycloalkyl-C₁-C₄alkyl; and
R₃ represents hydrogen or a substituent selected from the group consisting of C₁-C₁₂alkyl, C₅-C₇cycloalkyl, (C₁-C₄alkyl)₁₋₃C₅-C₇cycloalkyl, C₅-C₇cycloalkyl-C₁-C₄alkyl, phenyl, phenyl-C₁-C₄alkyl, (C₁-C₄alkyl)₁₋₃phenyl and (C₁-C₄alkyl)₁₋₃phenyl-C₁-C₄alkyl; and

B) A functional fluid selected from the group consisting of lubricants, hydraulic agents, metal working fluids and coating agents.

In any particular embodiment of the invention, including those not mentioned above, the weight ratio of the benzotriazole compound b) to the benzotriazole compound a) may be at least 0.052. In alternate embodiments, the weight ratio of the benzotriazole compound b) to the benzotriazole compound a) may be not greater than 0.215. In embodiments where the weight ratio of b) to a) is at least 0.052 and not greater than 0.215, the performance of each mixture is improved, for example, each mixture exhibits advantageous corrosion inhibitor properties.

The compositions defined above are prepared by conventional mixing procedures and are suitable as metal deactivators in functional liquids.

The expressions and terms used above and below are preferably defined as follows in the description of the present invention:

### Component A)

The compounds (I) present in the compositions according to the invention are defined by the following isomeric structures:

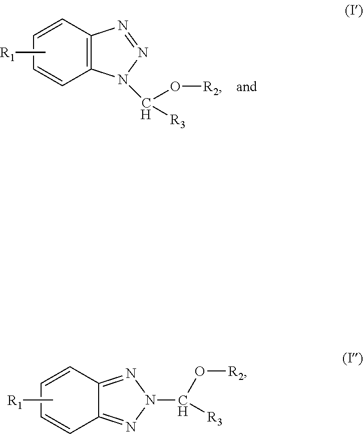

Wherein R₁, R₂ and R₃ are as defined above.

The term isomer includes any structural and positional isomers, tautomeric forms, cis-trans isomers and stereoisomers, e.g. enantiomeric forms and racemic mixtures.

R₁ and R₁′ defined as C₁-C₄alkyl represents methyl, ethyl, n-propyl, isopropyl, n-butyl, isobutyl or tert-butyl. According to a preferred embodiment, R₁ represents methyl.

R₂ represents a substituent selected from the group consisting of C₁-C₁₂alkyl, C₅-C₇cycloalkyl, (C₁-C₄alkyl)₁₋₃C₅-C₇cycloalkyl or C₅-C₇cycloalkyl-C₁-C₄alkyl.

R₂ defined as C₁-C₁₂alkyl represents C₁-C₄alkyl as defined above with regard to R₁ and R₁′ and additionally represents straight chain or branched C₅-C₁₂alkyl, e.g. pentyl, hexyl, heptyl, octyl, nonyl, undecyl or dodecyl.

R₂ defined as C₅-C₇cycloalkyl is preferably cyclopentyl or cyclohexyl.

R₂ defined as (C₁-C₄alkyl)₁₋₃C₅-C₇cycloalkyl is preferably cyclopentyl or cyclohexyl substituted with C₁-C₄alkyl, e.g. methyl, ethyl, n-propyl, isopropyl, n-butyl, isobutyl or tert-butyl.

R₂ defined as C₅-C₇cycloalkyl-C₁-C₄alkyl is e.g. cyclopentylmethyl, cyclohexylmethyl, cyclopentyl-1,1-ethyl, cyclohexyl-1,1-ethyl, cyclopentyl-1,2-ethyl or cyclohexyl-1,2-ethyl.

In the compound (I) the index a represents a numeral from 1 to 10, and the index n represents a numeral from 2 to 8.

According to a preferred embodiment, the index a represents a numeral from 1 to 6, and the index n represents a numeral from 2 to 6.

According to another preferred embodiment, the index a represents a numeral from 1 to 4, and the index n represents a numeral from 2 to 4.

R₃ represents a substituent a substituent selected from the group consisting of C₁-C₁₂alkyl, C₅-C₇cycloalkyl, (C₁-C₄alkyl)₁₋₃C₅-C₇cycloalkyl, C₅-C₇cycloalkyl-C₁-C₄alkyl, phenyl, phenyl-C₁-C₄alkyl, (C₁-C₄alkyl)₁₋₃phenyl and (C₁-C₄alkyl)₁₋₃phenyl-C₁-C₄alkyl.

R₃ defined as C₁-C₁₂alkyl, C₅-C₇cycloalkyl, (C₁-C₄alkyl)₁₋₃C₅-C₇cycloalkyl and C₅-C₇cycloalkyl-C₁-C₄alkyl has the same meanings as defined above with regard to R₂.

R₃ defined as phenyl, phenyl-C₁-C₄alkyl, (C₁-C₄alkyl)₁₋₃phenyl and (C₁-C₄alkyl)₁₋₃phenyl-C₁-C₄alkyl is, for example, phenyl, benzyl, 1- or 2-phenylethyl, 4-methyl or 4-ethyl, cumyl or 4-methylbenzyl.

Compounds of the formula (I) are known from the disclosure of EP 0 365 476, or can be prepared in a manner analogous to the methods as described therein, e.g. by the acid catalysed reaction of the R₁-substituted benzotriazole, e.g. tolutriazole (tolyltriazole), with the aldehyde R₃—C(═O)—H and the alcohol R₂—OH in a solvent inert to the reactants, while continuously removing an azeotropic mixture of solvent and water formed during the reaction.

Suitable acid catalysts include mineral acids, e.g. sulphuric acid, acid clays, e.g. bentonite, montmorillonite, Bleicherde Tonsil® (Supreme 110 FF, 126 FF) or Fuller's earth, acid ion-exchange resins, e.g. Amberlyst® 15, and sulphonic acids, e.g. p-toluene sulphonic acid.

The inert solvent may be cyclohexane, benzene, toluene, xylene or carbon tetrachloride.

Compounds (I) wherein R₂ represents a group of the partial formulae (A) or (B), can be prepared in an analogous manner by the acid catalysed reaction of the R₁-substituted benzotriazole, e.g. tolutriazole (tolyltriazole), with the diol HO—(CH₂)₂₋₃O—(CH₂₋₃O)ₐ—(CH₂₋₃)—OH and 2 equivalents of the aldehyde R₃—(C═O)—H, or with the diol HO—(CH₂)ₙ—OH and 2 equivalents of the aldehyde R₃—(C═O)—H.

In a compound (II) R₁ defined as C₁-C₄alkyl represents methyl, ethyl, n-propyl, isopropyl, n-butyl, isobutyl or tert-butyl. According to a preferred embodiment, R₁ represents methyl.

Compounds (II) are known and are commercially available, e.g. Irgamet® (Ciba Specialty Chemicals) TTA.

According to any particular embodiment of the invention, the weight ratio of the benzotriazole compound b) to the benzotriazole compound a) may be at least 0.052. In alternate embodiments, the weight ratio of the benzotriazole compound b) to the benzotriazole compound a) may be not greater than 0.215.

The compounds (III) present in the compositions according to the invention are preferably defined by the following isomeric structure:

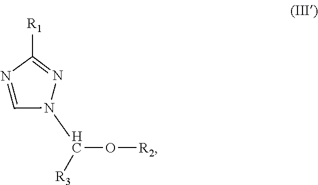

Wherein R₁, R₂ and R₃ are as defined above.

Compounds (III), according to the optional component c), can be prepared in a manner analogous to EP 0 365 476, e.g. by the acid catalysed reaction of a R₁-substituted triazole, e.g. triazole or methyltriazole, with the aldehyde R₃—C(═O)—H and the alcohol R₂—OH.

Compounds (III), wherein R₂ represents a group of the partial formula (A) or (B), can be prepared in an analogous manner by the acid catalysed reaction of the R₁-substituted triazole, e.g. triazole or methyltriazole, with the diol HO—(CH₂)₂₋₃O—(CH₂₋₃O)ₐ—(CH₂₋₃)—OH and 2 equivalents of the aldehyde R₃—(C═O)—H, or with the diol HO—(CH₂)ₙ—OH and 2 equivalents of the aldehyde R₃—(C═O)—H.

### Component B)

The term functional liquid selected from the group consisting of lubricants, hydraulic agents, metal working fluids and coating agents includes non-aqueous, partially aqueous and aqueous liquids which are in contact with metals to be deactivated, in particular copper or iron.

Examples of non-aqueous functional liquids are fuels, e.g. hydrocarbon mixtures comprising mineral oil fractions which are liquid at room temperature and are suitable for use in internal combustion engines, e.g. internal combustion engines with external (petrol engines) or internal ignition (diesel engines), e.g. petrol having different octane contents (regular grade or premium grade petrol) or diesel fuel, and lubricants, hydraulic fluid, metal working fluid, engine coolants, transformer oil and switch gear oil.

Examples of suitable partially aqueous functional liquids are hydraulic fluids based on aqueous polyglycol/polyglycol ether mixtures or glycol systems, water-in-oil or oil-in-water systems and engine cooling systems based on aqueous glycol.

Examples of aqueous functional liquids are industrial cooling water, filling compositions of a water conditioning plant, steam generation systems, sea water evaporation systems, sugar evaporation systems, irrigation systems, hydrostatic boilers and heating systems or cooling systems having a closed circulation.

The compositions according to the invention preferably comprise 0.01 to 5.0% by weight, in particular 0.02 to 1.0% by weight, of a compound (I), based on the weight of the functional liquid.

Non-aqueous functional liquids are preferred, in particular base oils of lubricating viscosity, which can be used for the preparation of greases, metal working fluids, gear fluids and hydraulic fluids.

Suitable greases, metal working fluids, gear fluids and hydraulic fluids are based, for example, on mineral or synthetic oils or mixtures thereof. The lubricants are familiar to a person skilled in the art and are described in the relevant literature, such as, for example, in Chemistry and Technology of Lubricants; Mortier, R. M. and Orszulik, S. T. (Editors); 1992 Blackie and Son Ltd. for GB, VCH-Publishers N.Y. for U.S., ISBN 0-216-92921-0, cf. pages 208 et seq. and 269 et seq.; in Kirk-Othmer Encyclopedia of Chemical Technology, Fourth Edition 1969, J. Wiley & Sons, New York, Vol. 13, page 533 et seq. (Hydraulic Fluids); Performance Testing of Hydraulic Fluids; R. Tourret and E. P. Wright, Hyden & Son Ltd. GB, on behalf of The Institute of Petroleum London, ISBN 0 85501 317 6; Ullmann's Encyclopedia of Ind. Chem., Fifth Completely Revised Edition, Verlag Chemie, DE-Weinheim, VCH-Publishers for U.S., Vol. A 15, page 423 et seq. (Lubricants), Vol. A 13, page 165 et seq. (Hydraulic Fluids).

The lubricants are in particular oils and greases, for example based on mineral oil or vegetable and animal oils, fats, tallow and wax or mixtures thereof. Vegetable and animal oils, fats, tallow and wax are, for example, palm kernel oil, palm oil, olive oil, colza oil, rapeseed oil, linseed oil, soy bean oil, cotton wool oil, sunflower oil, coconut oil, maize oil, castor oil, walnut oil and mixtures thereof, fish oils, and chemically modified, e.g. epoxidised or sulphoxidised, forms or forms prepared by genetic engineering, for example soy bean oil prepared by genetic engineering.

Examples of synthetic lubricants include lubricants based on aliphatic or aromatic carboxylic esters, polymeric esters, polyalkylene oxides, phosphoric acid esters, poly-α-olefins or silicones of the diester of a dibasic acid with a monohydric alcohol, e.g. dioctyl sebacate or dinonyl adipate, of a triester of trimethylolpropane with a monobasic acid or with a mixture of such acids, e.g. trimethylolpropane tripelargonate, trimethylolpropane tricaprylate or mixtures thereof, of a tetra ester of pentaerythritol with a monobasic acid or with a mixture of such acids, e.g. pentaerythrityl tetracaprylate, or of a complex ester of monobasic and dibasic acids with polyhydric alcohols, e.g. a complex ester of trimethylolpropane with caprylic and sebacic acid or of a mixture thereof. Particularly suitable in addition to mineral oils are, for example, poly-a-olefins, ester-based lubricants, phosphates, glycols, polyglycols and polyalkylene glycols and mixtures thereof with water.

Said lubricants or mixtures thereof can also be mixed with an organic or inorganic thickener (base fat). Metal working fluids and hydraulic fluids can be prepared on the basis of the same substances as described above for the lubricants. These are frequently also emulsions of such substances in water or other liquids.

### Additional Components

A further embodiment of the invention relates to a composition, which comprises additional additives selected from the group consisting of metal deactivators, antioxidants, rust inhibitors, viscosity index improvers, pour-point depressants, dispersants, surfactants, extreme-pressure additives, and antiwear additives.

Such additives are added in the amounts customary in each case for the purpose, each in the range from 0.01 to 10.0% by weight. Examples of further additives are listed below:

1. Phenolic antioxidants

1.1. Alkylated monophenols: 2,6-di-tert-butyl-4-methylphenol, 2-butyl-4,6-dimethylphenol, 2,6-di-tert-butyl-4-ethylphenol, 2,6-di-tert-butyl-4-n-butylphenol, 2,6-di-tert-butyl-4-iso-butylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, linear nonylphenols or nonylphenols which are branched in the side chain, e.g. 2,6-dinonyl-4-methylphenol, 2,4-dimethyl-6-(1′-methyl-undec-1′-yl)-phenol, 2,4-dimethyl-6-(1′-methylheptadec-1′-yl)-phenol, 2,4-dimethyl-6-(1′-methyl-tridec-1′-yl)-phenol and mixtures thereof.

1.2. Alkylthiomethylphenols: 2,4-dioctylthiomethyl-6-tert-butylphenol, 2,4-dioctylthiomethyl-6-methylphenol, 2,4-dioctylthiomethyl-6-ethylphenol, 2,6-dido-decylthiomethyl-4-nonylphenol

1.3. Hydroquinones and alkylated hydroquinones: 2,6-di-tert-butyl-4-methoxyphenol, 2,5-di-tert-butyl-hydroquinone, 2,5-di-tert-amyl-hydroquinone, 2,6-diphenyl-4-octadecyloxyphenol, 2,6-di-tert-butyl-hydroquinone, 2,5-di-tert-butyl-4-hydroxyanisole, 3,5-di-tert-butyl-4-hydroxyanisole, 3,5-di-tert-butyl-4-hydroxyphenylstearate, bis(3,5-di-tert-butyl-4-hydroxyphenyl)adipate

1.4. Tocopherols: α-, β-, γ- or δ-tocopherols and mixtures thereof (vitamin E)

1.5. Hydroxylated thiodiphenyl ethers: 2,2′-thiobis(6-tert-butyl-4-methylphenol), 2,2′-thiobis(4-octylphenol), 4,4′-thiobis(6-tert-butyl-3-methylphenol), 4,4′-thiobis-(6-tert-butyl-2-methylphenol), 4,4′-thiobis(3,6-di-sec-amylphenol), 4,4′-bis(2,6-dimethyl-4-hydroxyphenyl)disulphide

1.6. Alkylidene bisphenols: 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclo-pentadiene, bis[2-(3′-tert-butyl-2′-hydroxy-5′-methyl-benzyl)-6-tert-butyl-4-methyl-phenyl]terephthalate, 1,1-bis(3,5-dimethyl-2-hydroxyphenyl)-butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra(5-tert-butyl-4-hydroxy-2-methylphenyl)pentane

1.7. O-, N- and S-benzyl compounds: 3,5,3′,5′-tetra-tert-butyl-4,4′-dihydroxydibenzyl ether, octadecyl 4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulphide, isooctyl 3,5-di-tert-butyl-4-hydroxybenzylmercaptoacetate

1.8. Hydroxybenzylated malonates: dioctadecyl 2,2-bis(3,5-di-tert-butyl-2-hydroxybenzyl)-malonate, dioctadecyl 2-(3-tert-butyl-4-hydroxy-5-methylbenzyl)malonate, didodecyl mercaptoethyl-2,2-bis(3,5-di-tert-butyl-4-hydroxybenzyl)malonate, di-[4-(1,1,3,3-tetramethylbutyl)-phenyl]-2,2-bis(3,5-di-tert-butyl-4-hydroxybenzyl)malonate

1.9. Hydroxybenzyl aromatics: 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol

1.10. Triazine compounds: 2,4-bisoctylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxy-phenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate

1.11. Acylaminophenols: 4-hydroxylauranilide, 4-hydroxystearanilide, octyl N-(3,5-di-tert-butyl-4-hydroxyphenyl)carbamate

1.12. Esters of beta-(3,5-di-tert-butyl-4-hydroxyphenyl)-propionic acid: with monohydric or polyhydric alcohols, e.g. with methanol, ethanol, n-octanol, isooctanol, octadecanol, 1,6-hexanediol, 1,9-nonanediol, ethylene glycol, 1,2-propanediol, neopentylglycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane

1.13. Esters of beta-(5-tert-butyl-4-hydroxy-3-methylphenyl)propionic acid: with monohydric or polyhydric alcohols, e.g. the alcohols with methanol, ethanol, n-octanol, isooctanol, octadecanol, 1,6-hexanediol, 1,9-nonanediol, ethylene glycol, 1,2-propanediol, neopentylglycol, thiodiethylene glycol, diethylene glycol, triethylene glycol, pentaerythritol, tris(hydroxyethyl) isocyanurate, N,N′-bis(hydroxyethyl)-oxalamide, 3-thiaundecanol, 3-thiapentadecanol, trimethylhexanediol, trimethylolpropane, 4-hydroxymethyl-1-phospha-2,6,7-trioxabicyclo[2.2.2]octane

1.14. Esters of beta-(3,5-dicyclohexyl-4-hydroxyphenyl)propionic acid: with monohydric or polyhydric alcohols, e.g. the alcohols stated under 13

1.15. Ester of 3,5-di-tert-butyl-4-hydroxyphenylacetic acid: with monohydric or polyhydric alcohols, e.g. the alcohols stated under 13

1.16. Amides of beta-(3,5-di-tert-butyl-4-hydroxyphenyl)propionic acid: N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine

1.17. Ascorbic acid (vitamin C)

1.18. Amine antioxidants: N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methyl-heptyl)-p-phenylenediamine, N,N′-dicyclohexyl-p-phenylenediamine, N,N′-diphenyl-p-phenylenediamine, N,N′-di-(naphth-2-yl)-p-phenylenediamine, N-isopropyl-N′-phenyl-p-phenylenediamine, N-(1,3-dimethyl-butyl)-N′-phenyl-p-phenylenediamine, N-(1-methylheptyl)-N′-phenyl-p-phenylenediamine, N-cyclohexyl-N′-phenyl-p-phenylenedi-amine, 4-(p-toluenesulphonamido)diphenylamine, N,N′-dimethyl-N,N′-di-sec-butyl-p-phenylenediamine, diphenylamine, N-allyldiphenylamine, 4-isopropoxy-diphenylamine, N-phenyl-1-naphthylamine, N-(4-tert-octylphenyl)-1-naphthylamine, N-phenyl-2-naphthylamine, octylated diphenylamine, e.g. p,p′-di-tert-octyldiphenylamine, 4-n-butylaminophenol, 4-butyrylaminophenol, 4-nonanoylamino-phenol, 4-dodecanoyla-minophenol, 4-octadecanoylaminophenol, di-(4-methoxyphenyl)amine, 2,6-di-tert-butyl-4-dimethylaminomethylphenol, 2,4′-diaminodiphenylmethane, 4,4′-diaminodiphenyl-methane, N,N,N′,N′-tetramethyl-4,4′-diaminodiphenylmethane, 1,2-di-[(2-methyl-phenyl)-amino]ethane, 1,2-di-(phenylamino)-propane, (o-tolyl)biguanide, di-[4-(1′,3′-dimethyl-butyl)phenyl]amine, tert-octylated N-phenyl-1-naphthylamine, mixture of mono- and dialkylated tert-butyl/tert-octyldiphenylamines, mixture of mono- and dialkylated nonyldiphenylamines, mixture of mono- and dialkylated dodecyldiphenylamines, mixture of mono- and dialkylated isopropyl/isohexyldiphenylamines, mixtures of mono- and dialkylated tert-butyldiphenylamines, 2,3-dihydro-3,3-dimethyl-4H-1,4-benzothiazine, phenothiazine, mixture of mono- and dialkylated tert-butyl tert-octylphenothiazines, mixture of mono- and dialkylated tert-octylphenothiazines, mixture of mono- and dialkylated nonyl-phenothiazines, N-allylphenothiazine, N,N,N′,N′-tetraphenyl-1,4-diaminobut-2-ene, N,N-bis-(2,2,6,6-tetramethylpiperidin-4-yl)-hexamethylenediamine, bis-(2,2,6,6-tetramethylpiperidin-4-yl) sebacate, 2,2,6,6-tetramethylpiperidin-4-one, 2,2,6,6-tetramethylpiperidin-4-ol

2. Further antioxidants: aliphatic or aromatic phosphites, esters of thiodipropionic acid or thiodiacetic acid or salts of dithiocarbamic or dithiophosphoric acid, 2,2,12,12-tetramethyl-5,9-dihydroxy-3,7,11-trithiatridecane and 2,2,15,15-tetra-methyl-5,12-dihydroxy-3,7,10,14-tetrathiahexadecane

3. Further metal deactivators, e.g. for copper:

3.1. Benzotriazoles and derivatives thereof: 2-mercaptobenzotriazole, 2,5-dimercaptobenzotriazole, 4- or 5-alkylbenzotriazoles (e.g. tolutriazole) and derivatives thereof, 4,5,6,7-tetrahydrobenzotriazole, 5,5′-methylenebisbenzotriazole; Mannich bases of benzotriazole or tolutriazole, such as 1-[di(2-ethylhexylaminomethl)tolutriazole and 1-[di(2-ethylhexylaminomethl)benzotriazole; alkoxyalkylbenzotriazoles, such as 1-(nonyloxymethyl)-benzotriazole, 1-(1-butoxyethyl)benzotriazole and 1-(1-cyclohexyloxybutyl)tolutriazole

3.2. 1,2,4-Triazoles and derivatives thereof: 3-alkyl (or aryl)-1,2,4-triazoles, Mannich bases of 1,2,4-triazoles, such as 1-[di(2-ethylhexyl)aminomethyl]-1,2,4-triazole; alkoxyalkyl-1,2,4-triazoles, such as 1-(1-butoxyethyl)-1,2,4-triazole; acylated 3-amino-1,2,4-triazoles

3.3. Imidazole derivatives: 4,4′-methylenebis(2-undecyl-5-methylimidazole), bis[(N-methyl)imidazol-2-yl]carbinol octyl ether

3.4. Sulphur-containing heterocyclic compounds: 2-mercaptobenzothiazole, 2,5-dimercapto-1,3,4-thiadiazole, 2,5-dimercaptobenzothiadiazole and derivatives thereof; 3,5-bis[di-(2-ethylhexyl)aminomethyl]-1,3,4-thiadiazolin-2-one

3.5. Amino compounds: salicylidenepropylenediamine, salicylaminoguanidine and salts thereof

4. Corrosion inhibitors

4.1. Organic acids, their esters, metal salts, amine salts and anhydrides: e.g. alkyl- and alkyenylsuccinic acids and partial esters thereof with alcohols, diols or hydroxycarboxylic acids, partial amides of alkyl- and alkenylsuccinic acids, 4-nonylphenoxyacetic acid, alkoxy- and alkoxyethoxycarboxylic acids, such as dodecyloxyacetic acid, dodecyloxy(ethoxy)acetic acid and amine salts thereof, and furthermore N-oleoylsarcosine, sorbitan monooleate, lead naphthenate, alkenylsuccinic anhydrides, e.g. dodecenylsuccinic anhydride, 2-(2-carboxyethyl)-1-dodecyl-3-methyl-glycerol and salts thereof, in particular sodium salts and triethanolamine salts

4.2. Nitrogen-Containing Compounds:

4.2.1 Tertiary aliphatic and cycloaliphatic amines and amine salts of organic and inorganic acids, e.g. oil-soluble alkylammonium carboxylates, and furthermore 1-[N,N-bis-(2-hydroxyethyl)amino]-3-(4-nonylphenoxy)propan-2-ol

4.2.2 Heterocyclic compounds, e.g. substituted imidazolines and oxazolines, e.g. 2-heptadecenyl-1-(2-hydroxyethyl)-imidazoline

5. Sulphur-containing compounds: barium dinonylnaphthalenesulphonates, calcium petroleum sulphonates, alkylthio-substituted aliphatic carboxylic acids, esters of aliphatic 2-sulphocarboxylic acids and salts thereof

6. Viscosity index improvers: polyacrylates, polymethacrylates, vinylpyrrolidone/methacrylate copolymers, polyvinylpyrrolidiones, polybutenes, olefin copolymers, styrene/acrylate copolymers, polyethers

7. Pour point depressants: poly(meth)acrylates, ethylene-vinyl acetate copolymers, alkyl polystyrenes, fumarate copolymers, alkylated naphthalene derivatives

8. Dispersants/Surfactants: polybutenylsuccinamides or polybutenylsuccinimides, polybutenylphosphonic acid derivatives, basic magnesium, calcium and barium sulphonates and phenolates

9. High pressure and antiwear additives: sulphur- and halogen-containing compounds, e.g. chlorinated paraffins, sulphonated olefins or vegetable oils (soy bean oil, rapeseed oil), alkyl or aryl di- or trisulphides, benzotriazoles or derivatives thereof, such as bis (2-ethylhexyl)aminomethyl tolutriazoles, dithio-carbamates, such as methylenebisdibutyl dithiocarbamate, derivatives of 2-mercaptobenzothiazole, such as 1-[N,N-bis(2-ethylhexyl)aminomethyl]-2-mercapto-1H-1,3-benzothiazole, derivatives of 2,5-dimercapto-1,3,4-thiadiazole, such as 2,5-bis(tert-nonyldithio)-1,3,4-thiadiazole

10. Substances for reducing the coefficient of friction: lard oil, oleic acid, tallow, rapeseed oil, sulphurised fats, amines. Further examples are stated in EP-A-0 565 487

11. Special additives for use in water/oil metal processing and hydraulic fluids:

11.1 Emulsifiers: petroleum sulphonates, amines, such as polyoxyethylated fatty amines, non-ionic surface-active substances

11.2 Buffers: alkanolamines

11.3 Biocides: triazines, thiazolinones, trisnitromethane, morpholine, sodium pyridinethiol

11.4 Processing speed improvers: calcium sulphonates and barium sulphonates.

Said components can be mixed with the lubricants in a manner known per se. It is also possible to prepare a concentrate or a so-called additive packet, which can be diluted to the concentrations of use for the corresponding lubricant according to consumption.

A preferred embodiment of the invention relates to a composition comprising
A) A mixture consisting essentially of
   a) A benzotriazole compound:

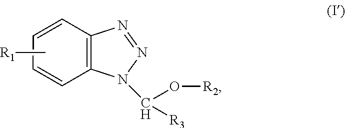

Wherein R₁ represents hydrogen or methyl;
R₂ represents a substituent selected from the group consisting of C₁-C₈alkyl, C₅-C₇cycloalkyl,

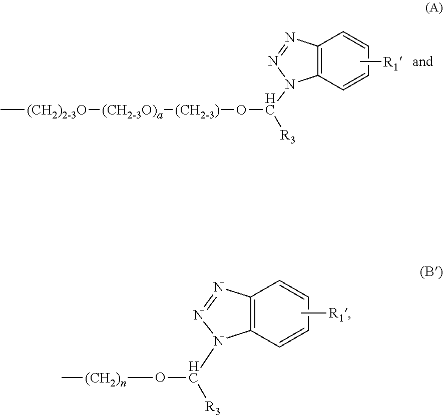

Wherein R₁′ is as defined as R₁;
The index a represents a numeral from 1 to 10;
The index n represents a numeral from 2 to 8; and
R₃ represents hydrogen or a substituent selected from the group consisting of C₁-C₈alkyl, C₅-C₇cycloalkyl and phenyl or an isomer of the compound (I′); and
b) A benzotriazole compound:

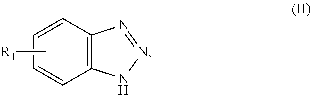

Wherein R₁ represents hydrogen or methyl; and
B) A functional fluid selected from the group consisting of lubricants, hydraulic agents, metal working fluids and coating agents.

Another preferredembodiment of the invention relates to a composition comprising
A) A mixture consisting essentially of
   a) A benzotriazole compound:

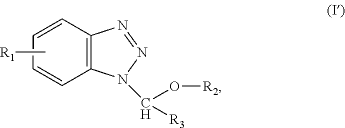

Wherein R₁ represents hydrogen or methyl;
R₂ represents a substituent selected from the group consisting of C₁-C₈alkyl, C₅-C₇cycloalkyl,

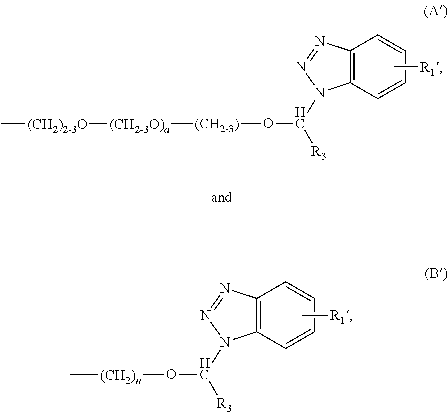

Wherein R₁′ is as defined as R₁,
The index a represents a numeral from 1 to 10;
The index n represents a numeral from 2 to 8, and
R₃ represents hydrogen or a substituent selected from the group consisting of C₁-C₈alkyl, C₅-C₇cycloalkyl and phenyl or an isomer of the compound (I′);
b) A benzotriazole compound:

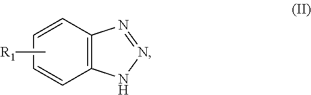

Wherein R₁ represents hydrogen or methyl; and
c) A triazole compound:

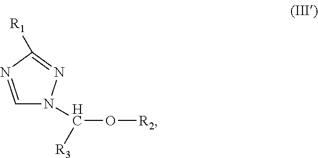

Wherein R₁ represents hydrogen or methyl;
R₂ represents a substituent selected from the group consisting of C₁-C₈alkyl, C₅-C₇cycloalkyl,

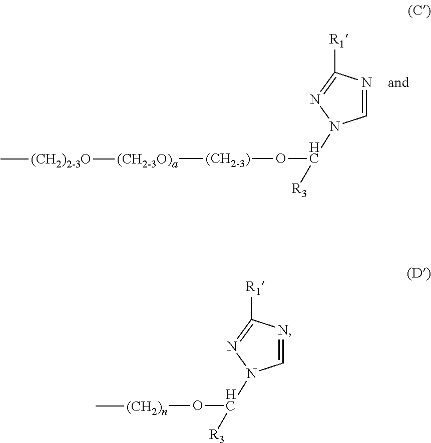

Wherein R₁′ is as defined as R₁; and
The index a represents a numeral from 1 to 10;
The index n represents a numeral from 2 to 8; and
R₃ represents hydrogen or a substituent selected from the group consisting of C₁-C₁₂alkyl, C₅-C₇cycloalkyl and phenyl; and
B) A functional fluid selected from the group consisting of lubricants, hydraulic agents, metal working fluids and coating agents.

The invention particularly refers to a composition comprising
A) A mixture consisting essentially of
   a) A benzotriazole compound (I′), wherein
      R₁ represents hydrogen or methyl;
      R₂ represents C₅-C₇cycloalkyl or the group (A′), wherein R₁′ is as defined as R₁; And the index a represents a numeral from 1 to 8; and
      R₃ represents C₁-C₈alkyl or C₅-C₇cycloalkyl or an isomer of the compound (I′); and
   b) benzotriazole compound (II), wherein
      R₁ represents hydrogen or methyl; and
B) A functional fluid selected from the group consisting of lubricants, hydraulic agents, metal working fluids and coating agents.

Another preferred embodiment of the invention relates to composition comprising
A) A mixture consisting essentially of
   a) A benzotriazole compound (I′), wherein
      R₁ represents hydrogen or methyl;
      R₂ represents C₅-C₇cycloalkyl or the group (A′), wherein R₁′ is as defined as R₁; And the index a represents a numeral from 1 to 8; and
      R₃ represents C₁-C₈alkyl or C₅-C₇cycloalkyl or an isomer of the compound (I′);
   b) A benzotriazole compound (II), wherein
      R₁ represents hydrogen or methyl; and
   c) A triazole compound (III), wherein
      R₁ represents hydrogen or methyl;
      R₂ represents C₅-C₇cycloalkyl or the group (B), wherein R₁′ is as defined as R₁; and The index a represents a numeral from 1 to 8; and
      R₃ represents C₁-C₈alkyl or C₅-C₇cycloalkyl or an isomer of the compound (I′); and
B) A functional fluid selected from the group consisting of lubricants, hydraulic agents, metal working fluids and coating agents.

A further embodiment of the invention relates to a mixture comprising
a) A benzotriazole compound (I), wherein
   R₁ represents hydrogen or C₁-C₄alkyl;
   R₂ represents a substituent selected from the group consisting of C₁-C₁₂alkyl, C₅-C₇cycloalkyl, (C₁-C₄alkyl)₁₋₃C₅-C₇cycloalkyl and C₅-C₇cycloalkyl-C₁-C₄alkyl or represents the group (A),
   Wherein R₁′ is as defined as R₁; and
   The index a represents a numeral from 1 to 10; and
   R₃ represents hydrogen or a substituent selected from the group consisting of C₁-C₁₂alkyl, C₅-C₇cycloalkyl, (C₁-C₄alkyl)₁₋₃C₅-C₇cycloalkyl, C₅-C₇cycloalkyl-C₁-C₄alkyl, phenyl, phenyl-C₁-C₄alkyl, (C₁-C₄alkyl)₁₋₃phenyl and (C₁-C₄alkyl)₁₋₃phenyl-C₁-C₄alkyl;
b) A benzotriazole compound (II), wherein
   R₁ represents hydrogen or C₁-C₄alkyl; and, optionally,
c) A triazole compound (III), wherein
   R₁ represents hydrogen or C₁-C₄alkyl;
   R₂ represents a substituent selected from the group consisting of C₁-C₁₂alkyl, C₅-C₇cycloalkyl, (C₁-C₄alkyl)₁₋₃C₅-C₇cycloalkyl and C₅-C₇cycloalkyl-C₁-C₄alkyl or represents the group (B), wherein
   R₁′ is as defined as R₁; and
   The index a represents a numeral from 1 to 10; and
   R₃ represents hydrogen or a substituent selected from the group consisting of C₁-C₁₂alkyl, C₅-C₇cycloalkyl, (C₁-C₄alkyl)₁₋₃C₅-C₇cycloalkyl, C₅-C₇cycloalkyl-C₁-C₄alkyl, phenyl, phenyl-C₁-C₄alkyl, (C₁-C₄alkyl)₁₋₃phenyl and (C₁-C₄alkyl)₁₋₃phenyl-C₁-C₄alkyl.

As described above, in any particular embodiment of the invention, including those not mentioned above, the weight ratio of the benzotriazole compound b) to the benzotriazole compound a) may be at least 0.052. In alternate embodiments, the weight ratio of the benzotriazole compound b) to the benzotriazole compound a) may be not greater than 0.215. In embodiments where the weight ratio of b) to a) is at least 0.052 and not greater than 0.215, the performance of each mixture is improved, for example, each mixture exhibits advantageous corrosion inhibitor properties. However, the weight ratios of b) to a) within this broad range may vary. Alternate embodiments of the invention include mixtures where the weight ratio of b) to a) is at least 0.078, alternatively at least 0.081, alternatively at least 0.104, alternatively at least 0.108, and alternatively at least 0.129. Additional embodiments of the invention include mixtures where the weight ratio of b) to a) is not more than 0.207, alternatively not more than 0.201, alternatively not more than 0.193, alternatively not more than 0.161, alternatively not more than 0.155 and alternatively not more than 0.135. Embodiments of the invention include mixtures where the weight ratio of b) to a) is from 0.052 to 0.215, from 0.078 to 0.207, from 0.081 to 0.201, from 0.104 to 0.193, or from 0.108 to 0.161. Embodiments of the invention also include mixtures where the weight ratio of b) to a) is from 0.052 to 0.207. Embodiments of the invention also include mixtures where the weight ratio of b) to a) is from 0.054 to 0.215.

Where the weight ratio of b) to a) is below 0.052, resulting mixtures generally exhibit decreased performance, such as undesirable oxidative decomposition, for example, corrosion. Where the weight ratio of b) to a) is above 0.215, mixtures generally lack stability as compound b) may precipitate out of each mixture and become insoluble in the mixture.

Alternate embodiments of the invention include mixtures in which the weight ratio of the benzotriazole compound b) to the benzotriazole compound a) is from 0.052 to 0.21. Additional embodiments of the invention include mixtures in which the weight ratio of the benzotriazole compound b) to the benzotriazole compound a) is from 0.054 to 0.215.

Each of the mixtures defined above is particularly useful in method for improving the functional properties of lubricants, hydraulic or metal-working fluids or coating compositions, which comprises adding to a functional fluid the mixture defined above and, optionally, further additives.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The following examples illustrate the invention:

### EXAMPLE 1

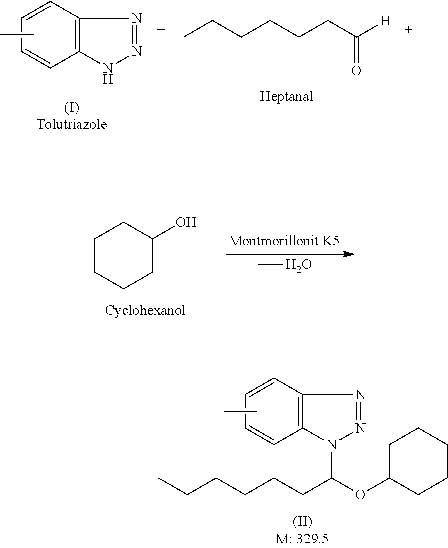

99.9 g (0.75 mol) (M: 133.2) tolutriazole (IRGAMET TTA, 2:3 mixture of 4(5)-methyl-1H-benzotriazole (2:3)), 75.15 g (0.75 mol) (M: 100.2) cyclohexanol (Riedel 24217) and 18.8 g (7% per weight based on the weight of all reactants) Montmorillonite K5 (Fluka 69908) are added to 147.0 g cyclohexane. The suspension is stirred and heated under reflux conditions. The water from the earth clay is removed for 30 min. in the gas phase and separated. 90.06 g (0.789 mol) (M: 144.2) heptanal are added within a time period of 30 min. The mixture is stirred and heated for 4 h under reflux conditions and, when the separation of water ceases, cooled to room temperature and filtered. The solvent is removed from the yellowish filtrate in the vacuum and a yellowish oil is obtained, which contains less than 1% Irgament TTA (HPLC). The yield of condensation product (II) when 99.9 g tolutriazole, 75.15 g cyclohexanol and 18.8 g Montmorillonite K5 are added to 147.0 g cyclohexane and reacted, as described above, is 247 g (0.75 mol) (M: 329.5). In the gas chromatogram 0.7% Irgamet TTA, 1.1% heptanal and 0.8% cyclohexanol are found.

### Elemental Analysis [%]:

| | C | H | N |
|---|---|---|---|
| Calc. | 72.91 | 9.48 | 12.75 |
| Found | 72.85/72.86 | 9.60/9.64 | 12.52/12.51 |

### EXAMPLE 1a

In an alternative embodiment of the process, Montmorillonit is replaced with Bleicherde Tonsil@ Supreme 110FF. The process of Example 1a is conducted in a manner analogous to the process of Example 1. 1,383 g (10.38 mol) (M: 133.2) tolutriazole (IRGAMET TTA, 2:3 mixture of 4(5)-methyl-1H-benzotriazole (2:3)), 751.5 g (7.50 mol) (M: 100.2) cyclohexanol (Riedel 24217) and 188 g Bleicherde Tonsil@ Supreme 110FF are added to 1,468 g cyclohexane. The suspension is stirred and heated under reflux conditions. The water from the earth clay is removed for 30 min. in the gas phase and separated. 900.6 g (7.89 mol) (m: 114.2) heptanal are added within a time period of 30 min. The mixture is stirred and heated for 4 h under reflux conditions and, when the separation of water ceases, cooled to room temperature and filtered. The solvent is removed from the yellowish filtrate in the vacuum and a yellowish oil is obtained. The yield of condensation product (II) is 2,853 g (8.65 mol) (M: 329.5) plus 13.5% (±1.5%) free Irgamet TTA. 14.0% Irgamet TTA correspond to 96.3% yield of expected condensation product (II) related on cyclohexanol at 100%.

### EXAMPLE 2

Mixtures comprising different amounts of tolutriazole (I) with regard to the condensation product (II) are prepared in a manner analogous to Example 1 by adding excess amounts of (I) to the reaction mixture:

| | Amounts [% by weight] | | | | | | |
|---|---|---|---|---|---|---|---|
| Components | B-1 | B-2 | B-3 | B-4 | B-5 | B-6 | B-7 |
| (II) | 95.0 | 92.5 | 90.0 | 87.5 | 85.0 | 82.5 | 80.0 |
| (I) | 5.0 | 7.5 | 10.0 | 12.5 | 15.0 | 17.5 | 20.0 |
| Total Weight (I) | 112.7 | 119.1 | 125.5 | 131.9 | 138.3 | 147.7 | 151.1 |
| Excess of (I) | 12.8 | 19.2 | 25.6 | 32.0 | 38.4 | 47.8 | 51.2 |

The mixture represented by B-1 has a corresponding weight ratio of excess of tolutriazole (I), i.e., 12.8 g, to yield of condensation product (II), i.e., 247 g, of 0.052. The mixture represented by B-7 has a corresponding weight ratio of excess of tolutriazole (I), i.e., 51.2 g, to yield of condensation product (II), i.e., 247 g, of 0.207.

In an example when the yield of condensation product (II) is 96.3% of the yield of the condensation product (II) above, e.g., the yield of condensation product (II) is 237.8 g of condensation product (II), the mixture represented by B-1 has a corresponding weight ratio of excess of tolutriazole (I), i.e., 12.8 g, to yield of condensation product (II), i.e., 237.8 g, of 0.054. The mixture represented by B-7 has a corresponding weight ratio of excess of tolutriazole (I), i.e., 51.2 g, to yield of condensation product (II), i.e., 237.8 g, of 0.215.

### EXAMPLE 3

### Application Tests

### 3.1 Methods

### 3.1.1 Rotary Bomb Oxidation Test ASTM D-2272

A 0.05% solution of the test composition in a mineral oil of turbine quality is prepared, which oil has a viscosity of 26.2 mm²/sec (40° C.) and 4.8 mm²/sec (100° C.) and a sulphur content of 0.54%. The solution can also contain a phenolic or amine antioxidant. The time required at a temperature of 150° C. for a minimum pressure drop of 1.75 bar starting from the maximum pressure of 6.2 bar is measured.

3.1.2 Modified ASTM D-130 Copper Strip Test

0.04% solution of the test composition in a poly-alpha-olefin (PAO), which has a viscosity of 7.7-8.0 cSt (100° C.) and a content of 50 ppm of elemental sulphur, is prepared. A copper strip (50×10×1 mm) is polished with grade 150 silicon carbide, which was absorbed with a wool pad wet with high-boiling petroleum ether. The polished strip is then completely immersed in the prepared solution, which is kept at 100° C. for two hours. The strip is then removed, washed with isooctane and dried and its colour is compared with the standardized colour samples of the tarnish chart, which is applicable for the corrosion test of copper strips according to ASTM D130.

### 3.2 Compositions Tested

| | Composition Tested [% by weight] | | | | | | | | | |
|---|---|---|---|---|---|---|---|---|---|---|
| Components | Control 1 | Control 2 | Control 3 | 1 (B-1) | 2 (B-2) | 3 (B-3) | 4 (B-4) | 5 (B-5) | 6 (B-6) | 7 (B-7) |
| Base Fluid¹⁾ | Bal. | Bal. | Bal. | Bal. | Bal. | Bal. | Bal. | Bal. | Bal. | Bal. |
| Antifoam²⁾ | 0.05 | 0.05 | 0.05 | 0.05 | 0.05 | 0.05 | 0.05 | 0.05 | 0.05 | 0.05 |
| Base | — | 0.38 | 0.38 | 0.38 | 0.38 | 0.38 | 0.38 | 0.38 | 0.38 | 0.38 |
| Formulation³⁾ | | | | | | | | | | |
| (II) | — | — | 0.04 | | | | | | | |
| Blends | — | — | | 0.04 | 0.04 | 0.04 | 0.04 | 0.04 | 0.04 | 0.04 |

¹⁾Group II, ISO 46 (blend of Jurong 150 and 500)
²⁾IRGALUBE AF 1
³⁾Base Formulation:

| Components | Amount [% by weight] |
|---|---|
| IRGANOX L57 | 39.5 |
| IRGANOX L135 | 39.5 |
| PANA | 15.8 |
| IRGACOR NPA | 2.6 |
| Sarkosyl O | 2.6 |

### 3.3 Results

| | Composition Tested [% by weight] | | | | | | | | | |
|---|---|---|---|---|---|---|---|---|---|---|
| Test | Control 1 | Control 2 | Control 3 | 1 (B-1) | 2 (B-2) | 3 (B-3) | 4 (B-4) | 5 (B-5) | 6 (B-6) | 7 (B-7) |
| RPVOT¹⁾ | 28 | 452 | 507 | 581 | 582 | 646 | 640 | 640 | 645 | 651 |
| D 130 rating | 4a | 4a | 3b | 1b+ | 1b+ | 1b+ | 1b+ | 1b+ | 1b+ | 1b+ |

¹⁾RPVOT: Average of duplicates, minutes; ASTM D 2272
²⁾Copper corrosion per ASTM D 130, 3 h at 125° C. with 50 ppm elemental sulphur present

The findings in the RPVOT show outstanding antioxidative properties exerted by representative compositions in a non-aqueous functional fluid in the presence of phenolic and aminic antioxidants.

The findings in the copper corrosion test show outstanding deactivation of copper, which is achieved in a non-aqueous functional fluid in the presence of representative blends.

1. A composition comprising
A) A mixture consisting essentially of
a) A benzotriazole compound of formula (I′) or (I″) 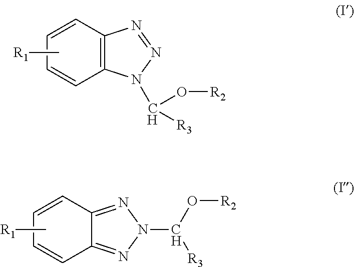
Wherein R₁ represents hydrogen or C₁-C₄ alkyl;
R₂ represents C₁-C₈alkyl or a substituent selected from the group consisting of C₁-C₁₂alkyl, C₅-C₇cycloalkyl, (C₁-C₄alkyl)₁₋₃C₅-C₇cycloalkyl and C₅-C₇cycloalkyl-C₁-C₄alkyl; and
R₃ represents hydrogen or a substituent selected from the group consisting of C₁-C₁₂alkyl, C₅-C₇cycloalkyl and, (C₁-C₄alkyl)₁₋₃C₅-C₇cycloalkyl, C₅-C₇cycloalkyl-C₁-C₄alkyl, phenyl, phenyl-C₁-C₄alkyl, (C₁-C₄alkyl)₁₋₃phenyl and (C₁-C₄alkyl)₁₋₃phenyl-C₁-C₄alkyl;
b) A benzotriazole compound of formula (II) 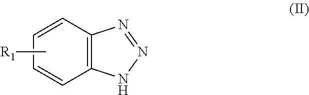
Wherein R₁ represents hydrogen or C₁-C₄alkyl, and
wherein the weight ratio of b) to a) is from 0.052 to 0.215; and
c) A triazole compound of formula (III′) 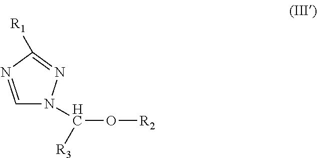
Wherein R₁ represents hydrogen or C₁-C₄alkyl;
R₂ represents a substituent selected from the group consisting of C₁-C₁₂alkyl, C₅-C₇cycloalkyl, (C₁-C₄alkyl)₁₋₃C₅-C₇cycloalkyl and C₅-C₇cycloalkyl-C₁-C₄alkyl; and
R₃ represents hydrogen or a substituent selected from the group consisting of C₁-C₁₂alkyl, C₅-C₇cycloalkyl, (C₁-C₄alkyl)₁₋₃C₅-C₇cycloalkyl, C₅-C₇cycloalky phenyl, phenyl-C₁-C₄alkyl, (C₁-C₄alkyl)₁₋₃phenyl and (C₁-C₄alkyl)₁₋₃phenyl-C₁-C₄alkyl;
and
B) A functional fluid selected from the group consisting of lubricants, hydraulic agents, metal working fluids and coating agents.

2. The composition of claim 1, wherein the weight ratio of b) to a) is 0.054 to 0.215.

3. The composition of claim 1, wherein the weight ratio of b) to a) is 0.052 to 0.207.

4. The composition of claim 1, comprising
A) A mixture consisting essentially of
a) A benzotriazole compound of formula (I′) or (I″) 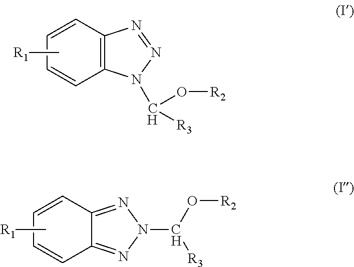
Wherein R₁ represents hydrogen or C₁-C₄ alkyl;
R₂ represents C₁-C₈alkyl or C₅-C₇cycloalkyl; and
R₃ represents hydrogen or a substituent selected from the group consisting of C₁-C₈alkyl, C₅-C₇cycloalkyl and phenyl;
b) A benzotriazole compound of formula (II) 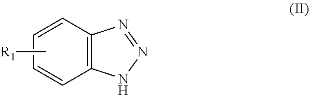
Wherein R₁ represents hydrogen or C₁-C₄alkyl; and
c) A triazole compound of formula (III′) 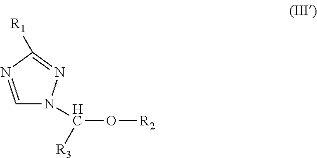
Wherein R₁ represents hydrogen or C₁-C₄alkyl;
R₂ represents a substituent selected from the group consisting of C₁-C₁₂alkyl, C₅-C₇cycloalkyl, (C₁-C₄alkyl)₁₋₃C₅-C₇cycloalkyl and C₅-C₇cycloalkyl-C₁-C₄alkyl; and
R₃ represents hydrogen or a substituent selected from the group consisting of C₁-C₁₂alkyl, C₅-C₇cycloalkyl, (C₁-C₄alkyl)₁₋₃C₅-C₇cycloalkyl, C₅-C₇cycloalkyl-C₁-C₄alkyl, phenyl, phenyl-C₁-C₄alkyl, (C₁-C₄alkyl)₁₋₃phenyl and (C₁-C₄alkyl)₁₋₃phenyl-C₁-C₄alkyl;
and
B) A functional fluid selected from the group consisting of lubricants, hydraulic agents, metal working fluids and coating agents.

5. A composition according to claim 1 comprising
A) A mixture consisting essentially of
a) A benzotriazole compound of formula (I′) 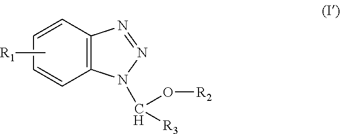
Wherein
R₁ represents hydrogen or methyl;
R₂ represents C₁-C₈alkyl or C₅-C₇cycloalkyl;
R₃ represents hydrogen or a substituent selected from the group consisting of C₁-C₈alkyl, C₅-C₇cycloalkyl and phenyl; and
b) A benzotriazole compound of formula (II) 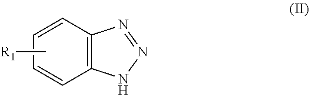
Wherein R₁ represents hydrogen or methyl; and
c) A triazole compound of formula (III′) 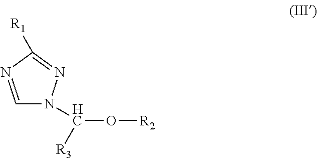
Wherein
R₁ represents hydrogen or methyl;
R₂ represents C₁-C₈alkyl or C₅-C₇cycloalkyl;
R₃ represents hydrogen or a substituent selected from the group consisting of C₁-C₈alkyl, C₅-C₇cycloalkyl and phenyl.
and
B) A functional fluid selected from the group consisting of lubricants, hydraulic agents, metal working fluids and coating agents.

6. A composition according to claim 1 comprising
A) A mixture consisting essentially of
a) A benzotriazole compound (I′), wherein
R₁ represents hydrogen or methyl;
R₂ represents C₅-C₇cycloalkyl; and
R₃ represents C₁-C₈alkyl or C₅-C₇cycloalkyl; and
b) A benzotriazole compound (II), wherein
R₁ represents hydrogen or methyl; and
c) A triazole compound (III′), wherein
R₁ represents hydrogen or methyl;
R₂ represents C₅-C₇cycloalkyl; and
R₃ represents C₁-C₈alkyl or C₅-C₇cycloalkyl;
and
B) A functional fluid selected from the group consisting of lubricants, hydraulic agents, metal working fluids and coating agents.

7. A composition comprising
A) A mixture consisting essentially of
a) A benzotriazole compound of formula (I′) 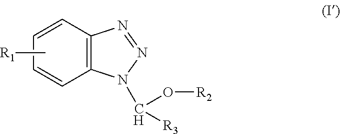
Wherein
R₁ represents hydrogen or methyl;
R₂ represents C₁-C₈alkyl or C₅-C₇cycloalkyl;
R₃ represents hydrogen or a substituent selected from the group consisting of C₁-C₈alkyl, C₅-C₇cycloalkyl and phenyl; and
b) A benzotriazole compound of formula (II) 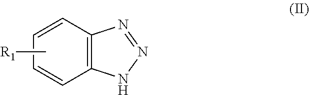
Wherein R₁ represents hydrogen or methyl and
wherein the weight ratio of b) to a) is from 0.052 to 0.215;
and
B) A functional fluid selected from the group consisting of lubricants, hydraulic agents, metal working fluids and coating agents.

8. The composition of claim 7 where the weight ratio of b) to a) is from 0.054 to 0.215.

9. The composition of claim 7 where the weight ratio b) to a) is from 0.052 to 0.207.

10. A composition according to claim 7 comprising
A) A mixture consisting essentially of
a) A benzotriazole compound (I′), wherein
R₁ represents hydrogen or methyl;
R₂ represents C₅-C₇cycloalkyl; and
R₃ represents C₁-Cₛalkyl or C₅-C₇cycloalkyl; and
b) A benzotriazole compound (II), wherein
R₁ represents hydrogen or methyl;
and
B) A functional fluid selected from the group consisting of lubricants, hydraulic agents, metal working fluids and coating agents.

11. A composition according to claim 1, which comprises additional additives selected from the group consisting of metal deactivators, antioxidants, rust inhibitors, viscosity index improvers, pour-point depressants, dispersants, surfactants, extreme-pressure additives and antiwear additives.

12. A composition according to claim 7, which comprises additional additives selected from the group consisting of metal deactivators, antioxidants, rust inhibitors, viscosity index improvers, pour-point depressants, dispersants, surfactants, extreme-pressure additives and antiwear additives.

13. A mixture comprising
a) A benzotriazole compound of formula (I′) or (I″) 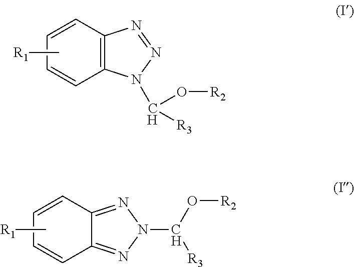
Wherein R₁ represents hydrogen or C₁-C₄ alkyl;
R₂ represents C₁-C₈alkyl or a substituent selected from the group consisting of C₁-C₁₂alkyl, C₅-C₇cycloalkyl, (C₁-C₄alkyl)₁₋₃C₅-C₇cycloalkyl and C₅-C₇cycloalkyl-C₁-C₄alkyl; and
R₃ represents hydrogen or a substituent selected from the group consisting of C₁-C₁₂alkyl, C₅-C₇cycloalkyl and, (C₁-C₄alkyl)₁₋₃C₅-C₇cycloalkyl, C₅-C₇cycloalkyl-C₁-C₄alkyl, phenyl, phenyl-C₁-C₄alkyl, (C₁-C₄alkyl)₁₋₃phenyl and (C₁-C₄alkyl)₁₋₃phenyl-C₁-C₄alkyl;
b) A benzotriazole compound of formula (II) 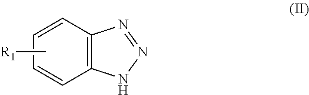
Wherein R₁ represents hydrogen or C₁-C₄alkyl, and
wherein the weight ratio of b) to a) is from 0.052 to 0.215; and
c) A triazole compound of formula (III′) 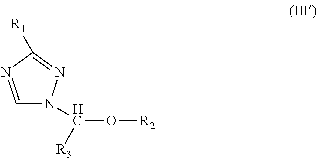
Wherein R₁ represents hydrogen or C₁-C₄alkyl;
R₂ represents a substituent selected from the group consisting of C₁-C₁₂alkyl, C₅-C₇cycloalkyl, (C₁-C₄alkyl)₁₋₃C₅-C₇cycloalkyl and C₅-C₇cycloalkyl-C₁-C₄alkyl; and
R₃ represents hydrogen or a substituent selected from the group consisting of C₁-C₁₂alkyl, C₅-C₇cycloalkyl, (C₁-C₄alkyl)₁₋₃C₅-C₇cycloalkyl, C₅-C₇cycloalkyl-C₁-C₄alkyl, phenyl, phenyl-C₁-C₄alkyl, (C₁-C₄alkyl)₁₋₃phenyl and (C₁-C₄alkyl)₁₋₃phenyl-C₁-C₄alkyl.

14. The mixture of claim 13, where the weight ratio of b) to a) is from 0.054 to 0.215.

15. The mixture of claim 13, where the weight ratio b) to a) is from 0.052 to 0.207.

16. A method for improving the functional properties of lubricants, hydraulic or metal-working fluids or coating compositions, which comprises adding thereto a mixture according to claim 13 and, optionally, further additives.

17. A composition according to claim 1, wherein R₁ is methyl.

18. A composition according to claim 7, wherein R₁ is methyl.

19. A composition according to claim 13, wherein R₁ is methyl.
